(19) United States
(12) Patent Application Publication
(10) Pub. No.: US 2008/0222349 A1
(43) Pub. Date: Sep. 11, 2008

(54) IEEE 1394 INTERFACE-BASED FLASH DRIVE USING MULTILEVEL CELL FLASH MEMORY DEVICES

(75) Inventors: Jong Kook Lee, Simi Valley, CA (US); Franz Michael Schuette, Sunnyvale, CA (US)

Correspondence Address: HARTMAN & HARTMAN, P.C., 552 EAST 700 NORTH, VALPARAISO, IN, 46383, US

(73) Assignee: OCZ TECHNOLOGY GROUP INC., Sunnyvale, CA (US)

(21) Appl. No.: 12/043,628

(22) Filed: Mar. 6, 2008

Related U.S. Application Data
(60) Provisional application No. 60/893,401, filed on Mar. 7, 2007.

(51) Int. Cl. G06F 12/00

(52) U.S. Cl. 711/103

(57) ABSTRACT

A flash drive and method of transferring data from a system to a flash drive. The flash drive includes a casing, a plurality of flash memory devices within the casing, each of the flash memory devices having multilevel cells, an IEEE 1394 interface controller within the casing, coupled to the flash memory devices, and interfacing with the flash memory devices for interleaved multichannel access to and from at least two of the flash memory devices, and at least one IEEE 1394 interface connector projecting from the casing for interfacing the flash memory devices with a system through the controller. The method entails coupling a plurality of multilevel cell flash memory devices to a system through an IEEE 1394 interface controller and at least one IEEE 1394 interface connector, and performing interleaved multichannel access to and from at least two of the flash memory devices.

### CROSS REFERENCE TO RELATED APPLICATIONS

This application claims the benefit of U.S. Provisional Application No. 60/893,401, filed Mar. 7, 2007, the contents of which are incorporated herein by reference.

### BACKGROUND OF THE INVENTION

The present invention generally relates to solid-state mass storage devices for data processing systems, including personal computers. More particularly, this invention relates to an external flash memory device capable of high sustained data access rates and high drive-to-system data transfer rates.

Mass storage devices include a variety of non-removable and removable media based mostly on either magnetic discs (for example floppy discs and hard disc drives), optical discs (for example CD-ROM, DVD-ROM) or solid state semiconductors (for example flash memory). Most vital data as the operating system and applications are usually stored on non-removable system drives using magnetic media, whereas permanent archiving is primarily done using optical media with practically unlimited shelf live. For mass archiving, routine back-up, digital linear tapes are often used, however this technology is not further considered relevant for the current application.

Data transfer between computers used to be done primarily via floppy discs that were relatively fast to write to and inexpensive. However, the maximum capacity of floppy drives is 2.88 MB, which suffices for small files but especially in the case of audio visual content is no longer acceptable. Optical media such as CD-ROM and DVD-ROM are relatively slow to write to and require specific hardware, that is, burners in order to write the data to the discs.

Alternative technologies have emerged in the form of solid state media, and span a wide range of formats that can be categorized under the general umbrella of memory cards and USB flash drives. USB flash drives (or simply “flash drives”) are known under various other names, “thumb drive” being a particularly widely-used example. As the name implies, flash drives contain flash memory, which stores information in an array of memory cells made from floating-gate transistors. Within the family of flash technologies, two general designs have been established, namely NOR flash and NAND flash. NOR flash is characterized by fast reads but slow writes and is therefore not suitable for rewritable mass storage media, whereas it is the media of choice for Read-Only-Memory storing, e.g., configuration data. NAND flash, on the other hand, has a much faster write speed, which compensates for slightly slower read performance compared to NOR flash and makes it the technology of choice for rewritable mass storage media.

Past generations of flash memory have faced the problem of high cost stemming from large die size, since every memory cell could only store one bit of data. The recent introduction of multilevel cells (MLC) has changed that, in that each cell can now store more than one bit by choosing among multiple levels of electrical charge that can be applied to the floating gate of each cell. As a consequence, MLC flash die size is greatly reduced, which translates directly into similarly reduced cost for manufacturing of MLC flash memory compared to single level cell (SLC) flash memory.

Serial interfaces have the advantage of low pin count and relative ease of implementation. The most widely used interface for serial data transfer to removable peripheral devices uses the universal serial bus (USB) that, in its second iteration, is capable of transferring up to 480 Mbit/sec. The advantage of the USB interface and protocol are its wide distribution, Plug-and-Play support within Microsoft® Windows® operating systems, and hot-plug capability. The USB protocol uses packetizing of information, that is, addresses, commands and data are combined into a single packet and transferred over the same lines or wires, which allows for the low pin count. The drawback of this mechanism is that there is no continuous transfer of data, since the data streams are interrupted by addresses and commands. Moreover, USB uses a master-slave architecture, meaning that all arbitration is carried out by the computer that, as a master, dictates the data flow to, from and between all peripherals. The arbitration overhead in particular limits the effective bandwidth of USB transfers to a fraction of the theoretical bandwidth of 480 Mbit/sec of the USB standard.

An alternative protocol is the IEEE1394 serial bus interface standard spearheaded by Apple Computer, Inc. Apple's version of this standard is under the name FireWire®, and uses a peer-to-peer architecture to provide high-speed communications and isochronous real-time data transfer. Currently, the IEEE 1394 standard is a composite of four documents, namely, the original IEEE standard 1394 (1995), the 1394a (2000) amendment, the 1394b (2002) amendment, and the 1394c (2006) amendment. Unless otherwise stated, reference to an IEEE standard interface encompasses interfaces that comply with any one or more of these documents. The two standards currently used are IEEE1394a and IEEE1394b with transfer rates of 400 Mbit/sec and 800 Mbit/sec, respectively. Industry is now standardizing the 1394c standard for even higher speeds.

The peer-to-peer architecture used by FireWire® enables intelligent peripherals to interact with each other through the FireWire® interface to determine the most efficient way to control data transfer, resulting in highly efficient utilization of its theoretical bandwidth. The peer-to-peer architecture and inter-device communication of the FireWire® protocol allow for up to 70% higher effective data transfer rates of FireWire compared to USB even at a higher nominal peak transfer of the USB 2.0 protocol. Because data transfers can use the full bandwidth of the FireWire® bus, FireWire® has become the interface of choice for high-bandwidth applications, such as audio-visual data transfers from camcorders to computers, and in high resolution digital cameras with burst capture capability as it can provide the high bandwidth of sustained throughput. FireWire® is available in various pin configurations, including the four-pin (without power) and six-pin (with power) FireWire® 400 connectors (IEEE 1394 and 1394a) used in standard personal computers, and the nine-pin FireWire® 800 connectors (IEEE 1394b) with a smaller interface form factor used primarily on laptops and cameras.

The use of a semiconductor memory and its use via a plug-in to a computer interface is disclosed in U.S. Pat. Nos. 5,404,485 and 5,717,886. U.S. Pat. No. 6,040,622 describes an archetype of a flash drive by disclosing the integration of a connector on the substrate that the electrically erasable programmable read only memory (EEPROM) is mounted on. The miniaturization of a flash storage device to a small form factor only marginally larger than the size of a USB connector is disclosed in U.S. Pat. No. 6,763,410.

The combination of the IEEE 1394 FireWire® interface and flash-memory based mass storage media is commonly used in the case of cameras, for example, see U.S. Pat. No. 6,151,652. In addition, memory card readers using a FireWire® interface to a host computer are disclosed in, for example, U.S. Pat. Nos. 6,438,638, 6,890,188, 7,162,549, 6,137,710, 6,738,259, and 7,162,549. In those cases, a card reader hub has a built-in FireWire® controller to interface with a computer's FireWire® port and, in addition, one or more card reader interfaces into which memory cards can be inserted. As a result, the contents of the memory card can be read using the fast FireWire® transfer speed. In addition, removable media that can be used as boot drives are disclosed in U.S. Pat. No. 7,136,951.

A basic flash drive is disclosed in U.S. Pat. No. 6,829,672 that uses a FireWire® or USB controller to interface with a flash chip, in which case both devices are integrated on the same printed circuit board. The described drive further has a FireWire® connector to be inserted into a computer. A similar approach in which a serial interface, in that case USB, is combined with another interface in order to increase versatility of the flash device is disclosed in U.S. Pat. No. 7,152,801. The possibility of using a FireWire® interface is also mentioned.

In order to speed up data transfers from the flash memory to the controller and, by extension, to a computer or other electronic device (hereinafter, “system”), high speed USB drives have started to use interleaved access of memory chips, meaning that data are split over several memory devices that can be accessed in a time-multiplexed fashion.

In summary, solid state semiconductor storage media and USB technology have evolved greatly over the past years. However, the recent advances in both flash memory technology and IEEE 1394 FireWire® technology have not converged and there has been no further development of high-speed IEEE 1394 FireWire® flash drives taking advantage of multi-chip and multi-channel interleaving and multilevel cell technology in combination with the streaming peer-to-peer data transfer protocol of FireWire®.

### BRIEF SUMMARY OF THE INVENTION

The current invention is a flash drive (used here to be synonymous with USB flash drive, thumb drive, etc.) that makes use of advancements in flash memory technology, including interleaving of several memory chips and several channels to a common I/O controller and the reduced footprint and cost of MLC flash devices, with the benefits of the IEEE1394 serial interface protocol, that is, an uninterrupted data stream between a system and the storage media.

According to a first aspect of the invention, a flash drive is provided that includes a casing, a plurality of flash memory devices within the casing, each of the flash memory devices having multilevel cells, an IEEE 1394 interface controller within the casing, coupled to the flash memory devices, and interfacing with the flash memory devices for interleaved multichannel access to and from at least two of the flash memory devices, and at least one IEEE 1394 interface connector projecting from the casing for interfacing the flash memory devices with a system through the controller.

According to a second aspect of the invention, a method of transferring data from a system to a flash drive entails coupling a plurality of multilevel cell flash memory devices to the system through an IEEE 1394 interface controller and at least one IEEE 1394 interface connector, and performing interleaved multichannel access to and from at least two of the flash memory devices.

Advantages associated with the invention include a cost-efficient design because of small footprint of MLC flash memory, high sustained data access rates through interleaved access of memory components, high drive-system transfer rates because of uninterrupted streaming using IEEE 1394 protocol in a peer-to-peer architecture, and high compatibility with existing system because of wide-spread adaptation of IEEE 1394 (e.g., FireWire®) for audio-visual content processing. With its higher bandwidth standard and high speed DRAM cache/SRAM cache, the flash drive of this invention has the capability of being an extremely fast removable mass storage device.

Other objects and advantages of this invention will be better appreciated from the following detailed description.

### BRIEF DESCRIPTION OF THE DRAWINGS

FIG. 1 is a perspective view of a flash drive in accordance with an embodiment of the invention.

FIG. 2 is a plan view of the flash drive of FIG. 1, in which the interior of the flash drive is exposed and internal hardware of the flash drive are represented.

FIG. 3 represents a hardware block diagram of the flash drive depicted in FIGS. 1 and 2.

### DETAILED DESCRIPTION OF THE INVENTION

The invention disclosed herein is a flash drive using an IEEE 1394 (e.g., FireWire®) interface and an internal controller that is capable of interleaved access of large capacity MLC (multilevel cell) NAND flash memory devices. The use of MLC NAND flash chips allows the use of the most cost effective flash memory devices with very high density, and the interleaving of several flash memory devices allows high sustained data transfer between the devices and the controller.

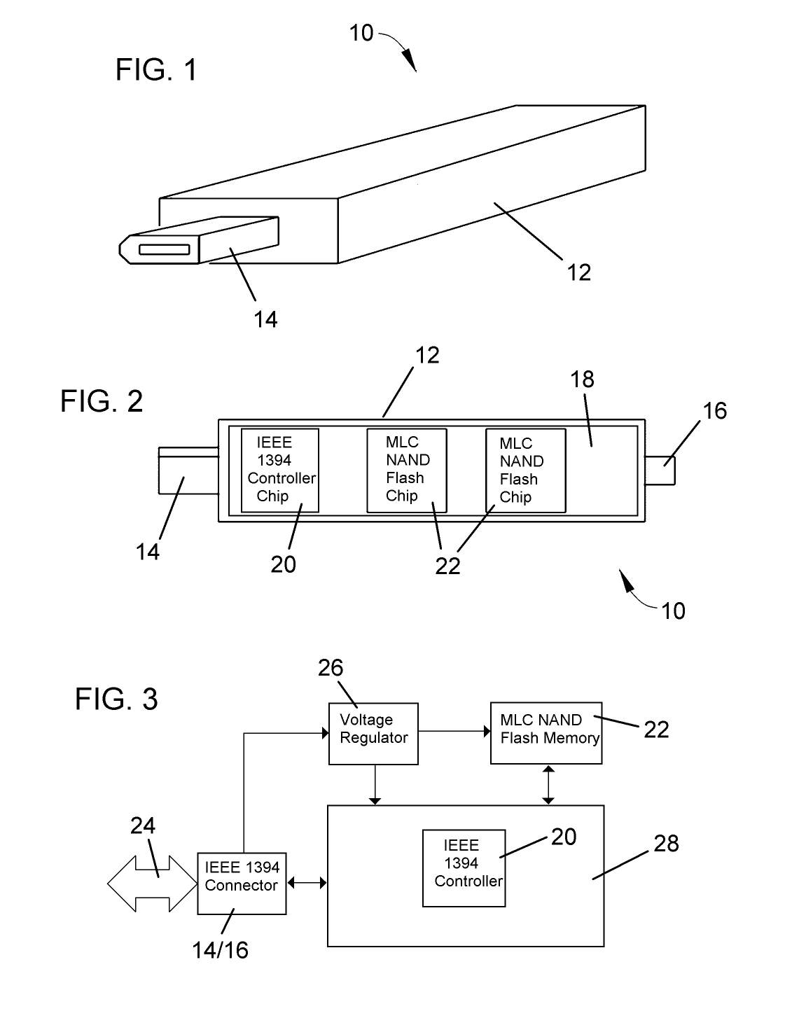

FIGS. 1 and 2 represent schematic overviews of a flash drive 10 that employs a IEEE 1394 interface, including an IEEE 1394 connector 14 and an IEEE 1394 controller chip 20, and multiple NAND flash memory devices 22 (of which only two are represented for convenience). The controller ship 20 and flash memory devices 22 are mounted on a printed circuit board 18 (or other suitable substrate) within a casing 12 having a small form factor as common in prior art USB flash drives. Suitable materials and assembly processes are well known in the industry, and therefore will not be discussed in any detail here. Examples of IEEE 1394 controller chips and NAND flash memory devices suitable for use with the invention include those summarized below in Table I.

TABLE I

| Manufacturer | Part No. | Short Description |
|---|---|---|
| INITIO | INIC-2430F | IDE to 1394 b high speed bridge |
| | | controller chip |
| Silicon Mition | SM223 | CF controller chip |
| Texas Instr. | TSB81BA3 | IEEE 1394 b 3-port cable |
| | | transceiver/arbiter chip |
| Samsung | K9K8G08U0A | 8 Gbit SLC NAND flash chip |
| Samsung | K9WAG08U1A | 16 Gbit SLC NAND flash chip |
| Samsung | K9NBG08U5A | 32 Gbit SLC NAND flash chip |
| Samsung | K9G8G08U0A | 8 Gbit MLC NAND flash chip |
| Samsung | K9LAG08U0A | 16 Gbit MLC NAND flash chip |
| Samsung | K9HBG08U1A | 32 Gbit MLC NAND flash chip |
| Samsung | K9HCG08U1M | 64 Gbit MLC NAND flash chip |
| Samsung | K9MDG08U5M | 128 Gbit MLC NAND flash chip |
| HYNIX | HY27UG088G5B | 8 Gbit SLC NAND flash chip |
| HYNIX | HY27UH08AG5B | 16 Gbit SLC NAND flash chip |
| HYNIX | HY27UK08BGFB | 32 Gbit SLC NAND flash chip |

As shown in FIG. 2, a useful variation of the flash drive 10 comprises a second IEEE 1394 connector 16 located at an end of the drive 10 oppositely-disposed from the connector 14. The connectors 14 and 16 preferably conform to two different interface form factors (large and small), such as the four, six, or nine-pin FireWire® 400 and 800 connectors, such that the flash drive 10 is compatible for use with a variety of electronic systems, including standard personal computers (PC's), laptops, cameras, etc.

FIG. 3 represents a hardware block diagram of the flash drive 10, in which an IEEE 1394 cable 24 is coupled to one of the connectors 14/16 for data transfer with the flash drive 10. The cable 24 supplies power to the connector 14/16, which is then routed to a voltage regulator 26 that delivers electrical power to the controller chip 20 and flash memory devices 22 in accordance with known principles. As represented in FIG. 3, the controller chip 20 will typically be a component of an access control circuit 28 that may further contain, for example, a microprocessor, multiplexer chips, etc.

On the system interface side, highly efficient data transfer is achieved by the use of the IEEE1394 serial bus interface standard, preferably the FireWire® protocol, and the use of interleaved multichannel access by which data and commands are transmitted between the controller chip 20 and two or more of the flash memory devices 22.

While the invention has been described in terms of a preferred embodiment, it is apparent that other forms could be adopted by one skilled in the art. Therefore, the scope of the invention is to be limited only by the following claims.

1. A flash drive comprising:
a casing;
a plurality of flash memory devices within the casing, each of the flash memory devices having multilevel cells;
an IEEE 1394 interface controller within the casing and coupled to the flash memory devices, the controller interfacing with the flash memory devices for interleaved multichannel access to and from at least two of the flash memory devices; and
at least one IEEE 1394 interface connector projecting from the casing for interfacing the flash memory devices with a system through the controller.

2. The flash drive according to claim 1, wherein the at least one IEEE 1394 interface connector comprises a first connector and a smaller connector.

3. The flash drive according to claim 2, wherein the first connector and the smaller connector are at oppositely-disposed ends of the casing.

4. The flash drive according to claim 2, wherein the first connector is a six-pin connector and the smaller connector is a nine-pin connector.

5. The flash drive according to claim 2, wherein the flash memory devices are NAND memory devices.

6. A method of transferring data from a system to a flash drive comprising coupling a plurality of multilevel cell flash memory devices to the system through an IEEE 1394 interface controller and at least one IEEE 1394 interface connector, and performing interleaved multichannel access to and from at least two of the flash memory devices.

7. The method according to claim 6, wherein the IEEE 1394 interface connector is a nine-pin connector.

8. The method according claim 7, further comprising providing the flash drive with a larger six-pin connector in addition to the nine-pin connector.
